(19) United States
(12) Patent Application Publication
(10) Pub. No.: US 2026/0172661 A1
(43) Pub. Date: Jun. 18, 2026

(54) CAMERA MODULE

(71) Applicant: LG INNOTEK CO., LTD., Seoul (KR)

(72) Inventor: Kwang Sung KIM, Seoul (KR)

(21) Appl. No.: 19/125,011

(22) PCT Filed: Nov. 9, 2023
(86) PCT No.: PCT/KR2023/018011

§ 371 Date: Apr. 28, 2025

(30) Foreign Application Priority Data
Nov. 10, 2022 (KR) 10-2022-0149977
Jan. 25, 2023 (KR) 10-2023-0009778

(51) Int. Cl. H04N 23/57; B60R 1/25; B60R 1/26; H04N 23/51; H04N 23/54; H04N 23/55

(52) U.S. Cl. CPC H04N 23/57; H04N 23/51; H04N 23/54; H04N 23/55; B60R 1/25; B60R 1/26

(57) ABSTRACT

This camera module comprises: a front body comprising a hole; a lens module having at least a portion thereof coupled to the hole; a rear body coupled to the rear surface of the front body; and a substrate module that is disposed within the rear body and comprises a first substrate on which an image sensor is disposed, a second substrate disposed at the rear of the first substrate, and a shield member coupled to the first substrate and the second substrate, wherein the second substrate has a protrusion formed on a side surface thereof, the shield member comprises a coupling hole into which the protrusion is coupled, and the protrusion has a cross-sectional area smaller than the cross-sectional area of the coupling hole.

### TECHNICAL FIELD

The present embodiment relates to a camera module.

### BACKGROUND ART

Recently, ultra-small camera modules have been developed and are widely used in small electronic products such as smartphones, laptops, and game consoles.

As automobiles become more popular, ultra-small cameras are widely used in vehicles as well as in small electronic products. For example, black box cameras for vehicle protection or objective data on traffic accidents, rear surveillance cameras that allow drivers to monitor the blind spots at the rear of the vehicle through a screen to ensure safety when reversing, and surrounding detection cameras that can monitor the surroundings of the vehicle are provided.

In the case of a camera module mounted on a vehicle, multiple substrates may be disposed within, and a structure capable of fixing multiple substrates in a state of being spaced apart within the camera module is required.

### DETAILED DESCRIPTION OF THE INVENTION

### Technical Subject

The present embodiment is intended to provide a camera module that can support multiple substrates and at the same time compensate for assembly tolerances between multiple parts so that they can be firmly coupled to one another.

### Technical Solution

A camera module according to the present embodiment comprises: a front body including a hole; a lens module having at least a portion thereof being coupled to the hole; a rear body being coupled to a rear surface of the front body; and a substrate module being disposed within the rear body, wherein the substrate module comprises: a first substrate on which an image sensor is disposed; a second substrate being disposed at the rear of the first substrate; and a shield member being coupled to the first substrate and the second substrate, wherein a protrusion is formed on a side surface of the second substrate, wherein the shield member includes a coupling hole into which the protrusion is coupled, and wherein the cross-sectional area of the protrusion is smaller than the cross-sectional area of the coupling hole.

The inner surface of the coupling hole includes: a first surface; a second surface being disposed opposite to the first surface; a third surface connecting the first surface and the second surface; and a fourth surface connecting the first surface and the second surface and opposite to the third surface, wherein an outer surface of the protrusion can be in contact with any one surface among the first to fourth surfaces.

The outer surface of the protrusion can be spaced apart from any one among the first to fourth surfaces and the other three surfaces.

The shield member includes a fence portion being disposed between the first substrate and the second substrate; and a coupling portion being protruded downward from a lower end of the fence portion and having the coupling hole formed therein, wherein a groove into which the coupling portion is coupled is formed on a side surface of the second substrate, and wherein the protrusion can be disposed on a bottom surface of the groove.

On an outside of an area being connected to an upper end of the connecting portion among a lower surface of the fence portion, a slit having a shape being recessed upward more than other areas may be disposed.

It may include a contact portion being extended downward from a lower end of the coupling portion and being in contact with an inner surface of the rear body.

The contact portion may include a first area being extended downwardly from a lower end of the coupling portion; a second area being extended downwardly from a lower end of the first area; and a bending portion being disposed between the first area and the second area and in contact with an inner surface of the rear body.

The contact portion may have elasticity such that an outer surface of the bending portion presses an inner surface of the rear body.

The first area may be disposed so as to be inclined so that the distance to an inner surface of the rear body becomes closer as it goes downward, and the second area may be disposed so as to be inclined so that the distance to an inner surface of the rear body becomes farther as it goes downward.

The length of the protrusion in a first direction may be 0.4 mm to 0.6 mm or less of the length of the coupling hole in a first direction, and the length of the protrusion in a second direction perpendicular to a first direction may be 0.2 mm to 0.3 mm or less of the length of the coupling hole in a second direction.

### Advantageous Effects

Through the present embodiment, the assembly tolerance is compensated for by the multiple directional movements of the second substrate to which the connector is coupled through the gap between the protrusion and the coupling hole, so there is an advantage in that the coupling of the rear body can be made easier.

In addition, there is an advantage in that the substrate module within the rear body can be more firmly fixed by the contact structure between the shield member and the rear body.

### BRIEF DESCRIPTION OF DRAWINGS

FIG. 1 is a perspective view illustrating the outer appearance of a camera module according to an embodiment of the present invention.

FIG. 2 is a drawing illustrating FIG. 1 except for a rear body.

FIG. 3 is a cross-sectional view of a camera module according to an embodiment of the present invention.

FIG. 4 is a perspective view of a substrate module according to an embodiment of the present invention.

FIG. 5 is an exploded perspective view of a camera module according to an embodiment of the present invention.

FIG. 6 is an enlarged view illustrating a coupling structure of a shield member and a second substrate according to an embodiment of the present invention.

FIG. 7 is a view illustrating a coupling structure between a rear body and a shield member according to an embodiment of the present invention.

FIG. 8 is a perspective view of a vehicle according to an embodiment of the present invention.

### BEST MODE

Hereinafter, preferred embodiments of the present invention will be described in detail with reference to the accompanying drawings.

However, the technical idea of the present invention is not limited to some embodiments to be described, but may be implemented in various forms, and inside the scope of the technical idea of the present invention, one or more of the constituent elements may be selectively combined or substituted between embodiments.

In addition, the terms (including technical and scientific terms) used in the embodiments of the present invention, unless explicitly defined and described, can be interpreted as a meaning that can be generally understood by a person skilled in the art, and commonly used terms such as terms defined in the dictionary may be interpreted in consideration of the meaning of the context of the related technology.

In addition, terms used in the present specification are for describing embodiments and are not intended to limit the present invention.

In the present specification, the singular form may include the plural form unless specifically stated in the phrase, and when described as “at least one (or more than one) of A and B and C”, it may include one or more of all combinations that can be combined with A, B, and C.

In addition, in describing the components of the embodiment of the present invention, terms such as first, second, A, B, (a), and (b) may be used. These terms are merely intended to distinguish the components from other components, and the terms do not limit the nature, order or sequence of the components.

And, when a component is described as being ‘connected’, ‘coupled’ or ‘interconnected’ to another component, the component is not only directly connected, coupled or interconnected to the other component, but may also include cases of being ‘connected’, ‘coupled’, or ‘interconnected’due that another component between that other components.

In addition, when described as being formed or disposed in “on (above)” or “below (under)” of each component, “on (above)” or “below (under)” means that it includes not only the case where the two components are directly in contact with, but also the case where one or more other components are formed or disposed between the two components. In addition, when expressed as “on (above)” or “below (under)”, the meaning of not only an upward direction but also a downward direction with respect to one component may be included.

The ‘optical axis direction’ used hereinafter is defined as the optical axis direction of the lens. Meanwhile, the ‘optical axis direction’ may correspond to ‘up-down direction’, ‘z-axis direction’, and the like.

Hereinafter, the present invention will be described in more detail with reference to the attached drawings.

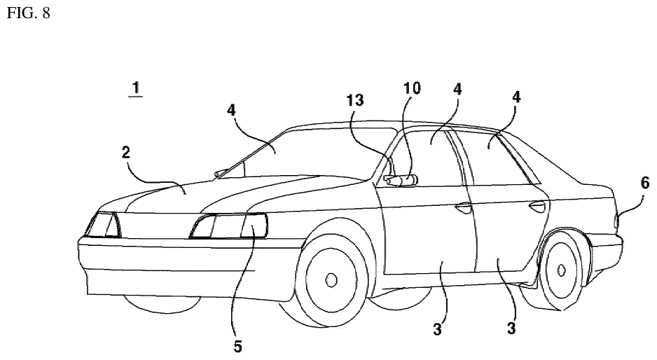

FIG. 8 is a perspective view of a vehicle according to an embodiment of the present invention.

Referring to FIG. 8, a vehicle 1 according to an embodiment of the present invention may include a body 2, a door 3, glass 4, a headlamp 5, a tail lamp 6, and a camera module 10.

The body 2 may be an exterior member of the vehicle 1. The body 2 may have various forms, such as a frame type and a monocoque type. One or more doors 3 may be coupled to a side surface of the body 2. In addition, the glass 4 may be coupled to the front and rear a portion where a pillar is formed of the upper portion of the body 2 and the door 3. The headlamp 5 may be mounted on the front of the lower portion of the body 2. The tail lamp 6 may be mounted on the rear of the lower portion of the body 2.

A camera module 10 may be installed on a side portion of the body 2 or on a door being disposed at the front of one or more of the doors 3. The camera module 10 may be installed in front of the glass 4 coupled to the door 3. That is, a side mirror in the vehicle 1 of the present embodiment may be redisposed with the camera module 10.

The camera module 10 can photograph images of both rear sides of the vehicle. Images photographed by the camera module 10 can be electrically connected to a display unit (not shown) through an electronic control unit (ECU), and the like. Accordingly, images photographed by the camera module 10 can be controlled by the electronic control unit (ECU) and played back on the display unit.

An interior space for a driver can be formed within the body 2. A display unit can be installed within the body 2. The display unit can output an image photographed by the camera module 10. The display unit can be installed on a dashboard (not shown) within the body 2.

The installation form of the camera module 10 within the vehicle 1 described above is exemplary, and the camera module 10 can be used in one or more among a front camera, a side camera, a rear camera, and a black box of the vehicle 1.

Hereinafter, a camera module according to an embodiment is described with reference to the drawings.

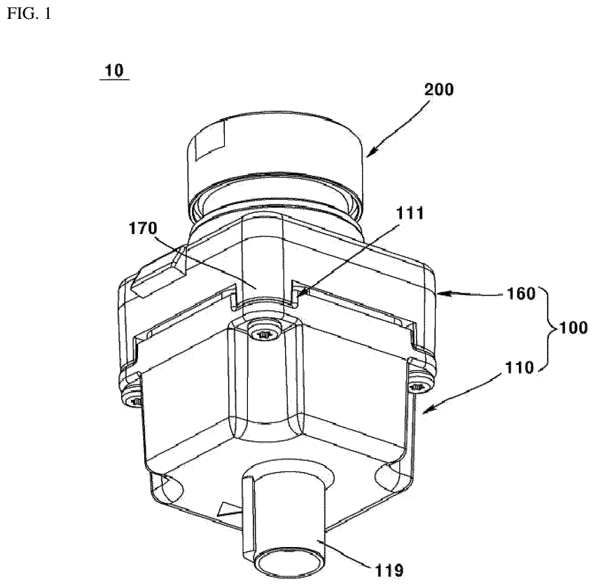

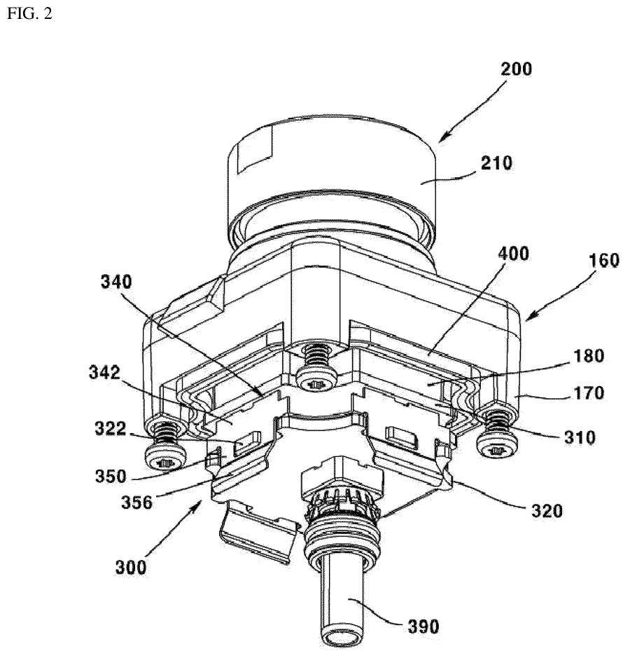

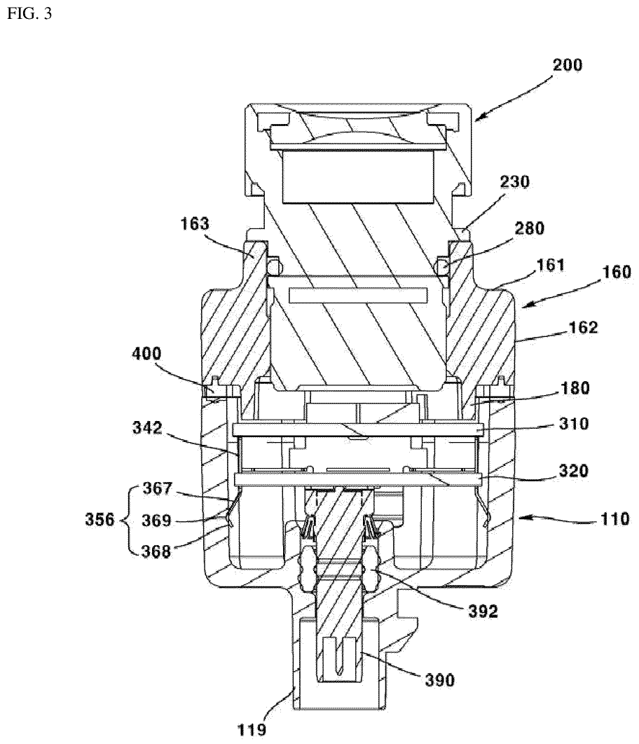

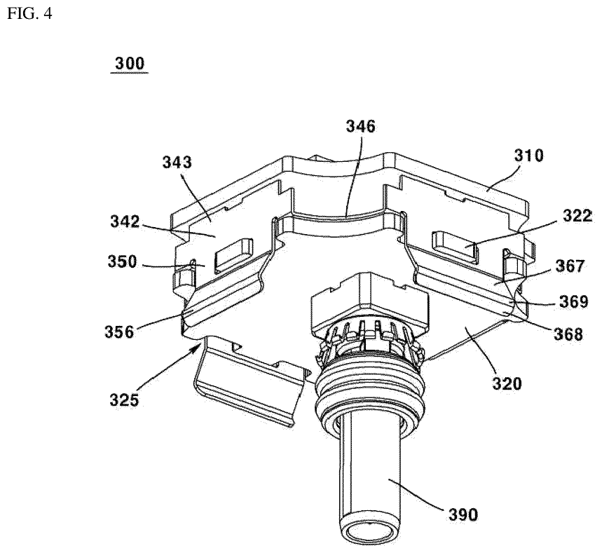

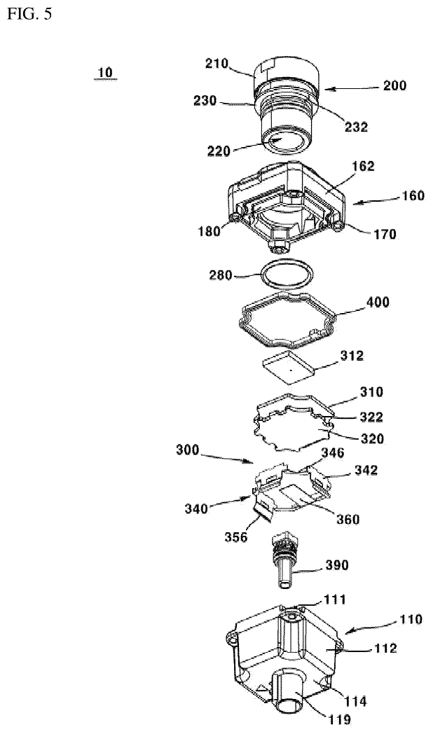

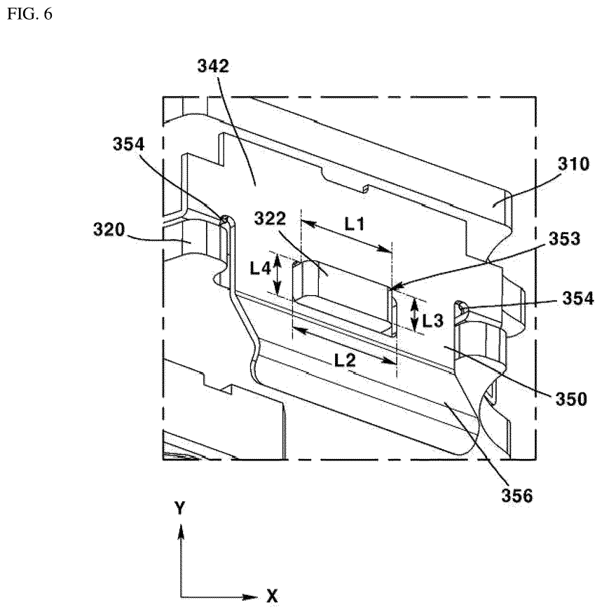

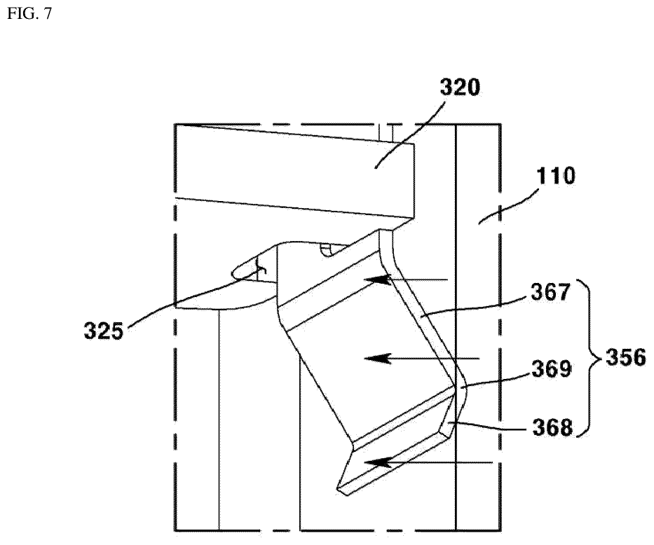

FIG. 1 is a perspective view illustrating the outer appearance of a camera module according to an embodiment of the present invention; FIG. 2 is a drawing illustrating FIG. 1 except for a rear body; FIG. 3 is a cross-sectional view of a camera module according to an embodiment of the present invention; FIG. 4 is a perspective view of a substrate module according to an embodiment of the present invention; FIG. 5 is an exploded perspective view of a camera module according to an embodiment of the present invention; FIG. 6 is an enlarged view illustrating a coupling structure of a shield member and a second substrate according to an embodiment of the present invention; and FIG. 7 is a view illustrating a coupling structure between a rear body and a shield member according to an embodiment of the present invention.

Referring to FIGS. 1 to 7, a camera module 10 according to an embodiment of the present invention may comprises a rear body 110, a front body 160, a lens module 200, a substrate module 300, and a sealing member 400, but may be implemented excluding some of the configurations, and additional configurations are not excluded.

The camera module 10 may include a rear body 110. The rear body 110 may be named any one of a first body, a lower housing, and a first housing. The rear body 110 may include a space therein to accommodate the substrate module 300. The space may be opened upward. The space may be covered by the front body 160. The rear body 100 may include a rectangular cross-sectional shape.

The rear body 110 may include a first side plate 112 and a bottom plate 114. The first side plate 112 may form a side surface of the rear body 110. The first side plate 112 may have a shape being bent from an edge of the bottom plate 114 and extended upward. The first side plate 112 may include four side plates. Each of the four first side plates 112 may have a square plate shape. The corner areas where the plurality of first side plates 112 is adjacent may have a groove shape being recessed inward more than other areas.

The bottom plate 114 forms a lower surface of the camera module 10 or the rear body 110, and can be connected to lower surfaces of the four first side plates 112. A connector lead-out portion 119 having a shape being protruded downwardly more than other areas can be disposed on a lower surface of the bottom plate 114. A connector 390, which will be described later, can be disposed on an inner side of the connector lead-out portion 119. The lower surface of the connector lead-out portion 119 can be protruded downwardly more than a lower surface of the bottom plate 114. An external terminal can be coupled to the connector lead-out portion 119, and accordingly, the camera module 10 can be electrically connected to the external terminal through the connector 390. Through the external terminal, the camera module 10 can be supplied with power, or can transmit and receive electrical signals related to the operation of the camera module 10.

A sealing member 392 (see FIG. 3) may be disposed between the inner surface of the connector lead-out portion 119 and the connector 390. It is possible to prevent external foreign substances from being introduced into the space of the connector lead-out portion 119 through the sealing member 392.

A coupling groove 111 having a shape recessed downward than other areas may be formed on an upper surface of the rear body 110. The coupling groove 111 may be disposed at each of four corner areas of the rear body 110. A screw hole may be formed in a bottom surface of the coupling groove 111 so that a screw penetrates therethrough. A coupling portion 170 of the front body 160 to be described later may be coupled to the coupling groove 111. The coupling portion 170 may be screw-coupled to the coupling groove 111 through the screw.

The camera module 10 may include a front body 160. The front body 160 may be referred to as one of a second body, an upper housing, and a second housing. A configuration formed by coupling the front body 160 and the rear body 110 may be referred to as a body or a housing. The front body 160 may form an inner space of the camera module 10 by coupling with the rear body 110. The front body 160 may have a rectangular cross-sectional shape. The front body 160 may have a shape in which upper and lower surfaces are opened.

The front body 160 may include a body portion and a barrel portion 163 (see FIG. 3). The body portion may include a second side plate 162 and an upper plate 161. The second side plate 162 may form a side surface of the front body 160. The second side plate 162 may have a shape being bent from an edge of the upper plate 161 and extended downward. The second side plate 162 may include four side plates. Each of the four second side plates 162 may have a square plate shape. An edge area adjacent to each of the plurality of second side plates 162 may be formed to be rounded. A lower surface of the second side plate 162 may be coupled to an upper surface of the first side plate 112.

The sealing member 400 may be disposed between the second side plate 162 and the first side plate 112. The sealing member 400 may be formed to correspond to a cross-sectional shape of a lower surface of the front body 160 and an upper surface of the rear body 110 to prevent external foreign substances from being introduced into the space within the camera module 10.

The upper plate 161 may form an upper surface of the front body 160. The upper plate 161 may be connected to upper ends of the four second side plates 162. The barrel portion 163 may be disposed on the upper plate 161. The barrel portion 163 may be formed to be protruded upward from an upper surface of the upper plate 161 compared to other areas. The barrel portion 163 may have a circular cross-sectional shape. A space, to which the lens module 130 is coupled, may be formed within the barrel portion 163.

The coupling portion 170 may be disposed on a lower surface of the front body 160. The coupling portion 170 may have a shape being protruded downward from a lower surface of the front body 160 than other areas. The coupling portion 170 may be disposed at corner areas of the front body 160, which are areas in which the plurality of second side plates 162 are adjacent to each other. A screw hole through which a screw penetrates may be formed on a lower surface of the coupling part 170. The coupling portion 170 may be coupled to the coupling groove 111 of the rear body 110.

A protrusion 180 may be disposed on a lower surface of the front body 160 to be protruded downward than other areas. The protrusion 180 may be disposed within the coupling portion 170. At least a portion of the protrusion 180 may be disposed in a space within the rear body 110. A lower end of the protrusion 180 may be disposed below a lower end of the coupling portion 170. A lower surface of the protrusion 180 may be coupled to an upper surface of the substrate module 300. A lower surface of the protrusion 180 may be coupled to an upper surface of a first substrate 310 of the substrate module 300 to be described later. An adhesive member (not shown) may be disposed between a lower surface of the protrusion 180 and the upper surface of the first substrate 310. The adhesive member may be epoxy. By adjusting the thickness of the adhesive member, the length in an optical axis direction between the image sensor 312 and the lens module 200 to be described later may be adjusted.

The camera module 10 may include a lens module 200. At least a portion of the lens module 200 may be coupled to a space within the front body 160, and another portion thereof may be protruded upward from the front body 160. A hole, to which the lens module 200 is coupled, is formed in an upper surface of the front body 160, and the lens module 200 may be coupled to the hole. At least a portion of the lens module 200 may be disposed to be overlapped the front body 160 in a direction perpendicular to the optical axis direction.

The lens module 200 may include a lens barrel 210 and at least one lens 220 being disposed within the lens barrel 210. The lens barrel 210 may have a circular cross-sectional shape. The lens barrel 210 may have a cylindrical shape with an open upper surface and a lower surface. The lens barrel 210 may have a plurality of areas having different cross-sectional areas. A screw thread or a screw groove may be formed on an outer circumferential surface of the lens barrel 210. A screw groove or a screw thread may be formed on an inner surface of the space within the front body 160 facing an outer circumferential surface of the lens barrel 210. Accordingly, the lens barrel 210 may be screw-coupled into the front body 160.

A groove 232 having a shape being recessed inward than that of other areas may be formed on an outer circumferential surface of the lens barrel 210. A sealing member 280 may be coupled to the groove 232. The sealing member 280 has a cross section of a ring shape and may be disposed between an outer circumferential surface of the lens barrel 210 and an inner surface of the front body 160. Therefore, it is possible to prevent foreign substances from being introduced into the space within the camera module 10.

A flange 230 being protruded more outwardly than other areas may be formed on an outer circumferential surface of the lens barrel 210. When the lens module 200 is coupled to the front body 100, the lower surface of the flange 230 may be disposed on an upper surface of the barrel portion 163. Accordingly, the coupling area of the lens module 200 within the front body 100 may be guided.

The lens 220 may be disposed within the lens barrel 210. A plurality of lenses 220 may be provided and disposed within the lens barrel 210 to be spaced apart from each other in the optical axis direction. The lens 220 may be disposed to face the image sensor 312 in an optical axis direction.

The camera module 10 may include the substrate module 300. The substrate module 300 may be disposed in a space within the camera module 10. The substrate module 300 may be disposed in a space within the rear body 110. The substrate module 300 may include a first substrate 310, a second substrate 320, a connection substrate (not shown), and a shield member 340.

The first substrate 310 may be a printed circuit board (PCB). The first substrate 310 may be coupled to an image sensor 312. The image sensor 312 may be disposed on the first substrate 310 to face the lens module 200 in an optical axis direction. A protrusion 180 of the front body 160 may be coupled to an upper surface of the first substrate 310 in the presence of an adhesive member.

The first substrate 310 may include four side surfaces. The first substrate 310 may include four corners connecting a plurality of adjacent side surfaces. Each of the four corners may have a groove shape being formed to be recessed inward than other areas. Each of the four corners may have a curved surface.

The second substrate 320 may be a printed circuit board (PCB). The second substrate 320 may be disposed to be spaced apart from the first substrate 310 in an optical axis direction. The second substrate 320 may be disposed below the first substrate 310. The connector 390 may be coupled to a bottom surface of the second substrate 320. An upper end of the connector 390 may be mounted on a bottom surface of the second substrate 320.

The second substrate 320 may be electrically connected to the first substrate 310. The second substrate 320 and the first substrate 310 may be electrically connected through the connection substrate. The connection substrate may be a flexible circuit board (FPCB). Upper and lower ends of the connection substrate may be coupled to the first substrate 310 and the second substrate 320, respectively.

The second substrate 320 may include four side surfaces. The second substrate 320 may include four corners connecting a plurality of adjacent side surfaces. Each of the four corners may have a groove shape being formed to be more recessed inward than other areas. Each of the four corners may have a curved surface.

A groove 325 (refer to FIG. 7) and a protrusion 322 (refer to FIG. 4) may be formed on a side surface of the second substrate 320. The groove 325 may have a shape being recessed more inwardly toward than other areas from a side surface of the second substrate 320. The groove 325 may be formed on three of the side surfaces of the second substrate 320. For example, when a side surface of the second substrate 320 includes a first side surface, a second side surface facing the first side surface, a third side surface connecting the first side surface and the second side surface, and a fourth side surface facing the third side surface, the grooves 325 may be formed on a first to third side surfaces, respectively.

The protrusion 322 may have a shape being protruded outward from a bottom surface of the groove 325. The protrusion 322 may be formed on three of the side surfaces of the second substrate 320 corresponding to the area in which the groove 325 is formed. The protrusion 322 may have a rectangular cross-sectional shape, but there is no limitation on the cross-sectional shape of the protrusion 322.

The shield member 340 may fix the first substrate 310 and the second substrate 320. At least a portion of the shield member 340 may be disposed between the first substrate 310 and the second substrate 320. The shield member 340 may be coupled to the first substrate 310 and the second substrate 320. The first substrate 310 and the second substrate 320 may be disposed to be spaced apart from each other with respect to an optical axis direction through the shield member 340. The shield member 340 may be formed of a metal material. The shield member 340 may be referred to as a shield can.

The shield member 340 may include a fence portion 342, a coupling portion 350, and a contact portion 356.

The fence portion 342 may be disposed between the first substrate 310 and the second substrate 320. The first substrate 310 and the second substrate 320 may be spaced apart from each other in an optical axis direction through the fence portion 342. An upper surface of the fence portion 342 may support a lower surface of the first substrate 310, and a lower surface of the fence portion 342 may support an upper surface of the second substrate 320.

A rib 343 may be formed on an upper surface of the fence portion 342 to be protruded more upward than other areas. Through the rib 343, an upper surface of the fence portion 342 may be coupled to a lower surface of the first substrate 310 by surface mounting technology (SMT).

A support portion 346 being in contact with an upper surface of the second substrate 320 may be disposed on a bottom surface of the fence portion 342. The support portion 346 may be coupled with an upper surface of the corner area of the second substrate 320. The support portion 346 may include a curved surface to correspond to the shape of a corner area of the second substrate 320.

The coupling portion 350 may have a shape being protruded downward from a bottom surface of the fence portion 342. The coupling portion 350 may be disposed to be overlapped with the second substrate 320 in a direction perpendicular to the optical axis direction. The coupling portion 350 may be coupled to the groove 325 of the second substrate 320. As illustrated in FIG. 6, the length of the groove 325 may be longer than the length of the coupling portion 350 with respect to a first direction X perpendicular to an optical axis direction Y.

The coupling portion 350 may include a coupling hole 353. The coupling hole 353 may have a shape penetrating from an inner surface to an outer surface of the coupling portion 350. A protrusion 322 of the second substrate 320 may be coupled to the coupling hole 353. At least a portion of the protrusion 322 may be protruded toward an outer side of the coupling portion 350 by penetrating the coupling hole 353. The coupling hole 353 may have a rectangular cross-sectional shape. For example, the coupling hole 353 may include a first surface forming an inner surface, a second surface facing the first surface, a third surface connecting the first surface and the second surface, and a fourth surface facing the third surface and connecting the first surface and the second surface. Here, the first surface and the second surface may have lengths smaller than those of the third surface and the fourth surface.

The cross-sectional area of the coupling hole 353 may be larger than the cross-sectional area of the protrusion 322. At least a portion of the protrusion 322 may be spaced apart from an inner surface of the coupling hole 353. When a surface of the protrusion 322 facing an inner surface of the coupling hole 353 is referred to as an outer surface, the outer surface of the protrusion 322 may include an area being spaced apart from an inner surface of the coupling hole 353.

As illustrated in FIG. 6, the length L1 in a first direction X of the protrusion 322 may be less than the length L2 in a first direction X of the coupling hole 353. The length L1 in a first direction X of the protrusion 322 may be equal to or less than 0.4 mm to 0.6 mm of the length L2 in a first direction X of the coupling hole 353.

The length L3 of the protrusion 322 in a second direction Y perpendicular to the first direction X and in an optical axis direction may be less than the length L4 of the coupling hole 353 in a second direction Y. The length L3 of the protrusion 322 in a second direction Y may be 0.2 mm to 0.3 mm less than the length L4 in a second direction Y of the coupling hole 353.

The protrusion 322 may be in contact with any one of inner surfaces of the coupling hole 353. For example, an outer surface of the protrusion 322 may be in contact with a third surface of the coupling hole 353, and may be spaced apart from a first surface, a second surface, and a fourth surface.

As illustrated in FIG. 2, the rear body 110 according to the present embodiment may be coupled to a rear surface of the front body 160 in a state in which the connector 390 is coupled to a lower surface of the second substrate 320. When the rear body 110 is coupled, a process of inserting the connector 390 into the connector lead-out portion 119 may be included. In this case, when the assembly tolerance between the substrate module 300 and the front body 160 or the assembly tolerance of the substrate module 300 occurs, insertion of the connector 390 into the connector lead-out portion 119 may not be easy, or damage to the substrate module 300 may occur during the insertion process of the connector 390. However, according to the present embodiment, since the second substrate 320 to which the connector 390 is coupled may move a predetermined distance in multiple directions through the separation space between the coupling hole 353 in the shield member 340 and the protrusion 322 of the second substrate 320, the connector lead-out portion 119 and the connector 390 may be more easily coupled.

Meanwhile, as illustrated in FIG. 6, a slit 354 having a shape being recessed more upward than other areas may be formed in an area of a lower surface of the fence portion 342, which is connected to an upper end of the coupling portion 350. The slits 354 may be disposed at both sides of an upper end of the coupling portion 350, respectively. The slit 354 may include a curved surface. Through the slit 354, the coupling portion 350 and the contact portion 356 may be easily bent with respect to the fence portion 342.

The coupling portion 350 may be disposed on a lower end of three surfaces of the fence portion 342 having a rectangular cross-sectional shape. In this case, the connection substrate may be disposed on a surface of the fence portion 342 in which the coupling portion 350 is not disposed. The shield member 340 may include a support plate 360 being bent inward from a lower end of a side surface of the fence portion 342 in which the coupling portion 350 is not formed to support the connection substrate. The connection substrate may be supported by a lower surface of the support plate 360.

The contact portion 356 may be extended downward from a lower end of the coupling portion 350. At least a portion of the contact portion 356 may come into contact with an inner surface of the rear body 110. The contact portion 356 may include a first area 367 being extended downward from a lower end of the coupling portion 350 and a second area 368 being extended downward from a lower end of the first area 367. The first area 367 may be obliquely disposed so that a distance to an inner surface of the rear body 110 becomes closer as it goes downward. The second area 368 may be obliquely disposed so that a distance to an inner surface of the rear body 110 increases as it goes downward. The first area 367 and the second area 368 may be disposed to form a predetermined angle.

A bending portion 369 of which an outer surface is in contact with an inner surface of the rear body 110 may be formed between the first area 367 and the second area 368. The bending portion 369 may be disposed to press an inner surface of the rear body 110.

The contact portion 356 may have an elastic force outwardly, which is a direction of pressing an inner surface of the rear body 110. In some cases, the coupling portion 350 may also have an elastic force outwardly with respect to a lower end of the fence portion 342 together with the contact portion 356. The length of the bending portion 369 being protruded from a side surface of the second substrate 320 before the rear body 110 is coupled may be greater than length of the bending portion 369 being protruded from a side surface of the second substrate 320 after the rear body 110 is coupled. An outer surface of the bending portion 369 in a state in which the rear body 110 is coupled may press the inner surface of the rear body 110 by an elastic force.

According to the above-described structure, when the rear body 110 is coupled, the coupling portion 350 may be coupled to the groove 325 of the second substrate 320 by a contact between the inner surface of the rear body 110 and the bending portion 369. In addition, there is an advantage that the coupling state of the substrate module 300 may be more firmly maintained within the rear body 110.

Meanwhile, the ground structure of the substrate module 300 may be implemented by the contact between the shield member 340 and the rear body 110.

In the above description, it is described that all the components constituting the embodiments of the present invention are combined or operated in one, but the present invention is not necessarily limited to these embodiments. In other words, inside the scope of the present invention, all of the components may be selectively operated in combination with one or more. In addition, the terms “comprise”, “include” or “having” described above mean that the corresponding component may be inherent unless specifically stated otherwise, and thus it should be construed that it does not exclude other components, but further include other components instead. All terms, including technical and scientific terms, have the same meaning as commonly understood by one of ordinary skill in the art unless otherwise defined. Terms used generally, such as terms defined in a dictionary, should be interpreted to coincide with the contextual meaning of the related art, and shall not be interpreted in an ideal or excessively formal sense unless explicitly defined in the present invention.

The above description is merely illustrative of the technical idea of the present invention, and those skilled in the art to which the present invention pertains may make various modifications and changes without departing from the essential characteristics of the present invention. Therefore, the embodiments disclosed in the present invention are not intended to limit the technical idea of the present invention but to describe the present invention, and the scope of the technical idea of the present invention is not limited by these embodiments. The protection scope of the present invention should be interpreted by the following claims, and all technical ideas inside the equivalent scope should be interpreted as being included in the scope of the present invention.

1. A camera module comprising:
a front body including a hole;
a lens module having at least a portion thereof coupled to the hole;
a rear body coupled to a rear surface of the front body; and
a substrate module disposed within the rear body,
wherein the substrate module comprises:
a first substrate on which an image sensor is disposed;
a second substrate disposed at the rear of the first substrate; and
a shield member coupled to the first substrate and the second substrate,
wherein a protrusion is formed on a side surface of the second substrate,
wherein the shield member includes a coupling hole into which the protrusion is coupled, and
wherein a cross-sectional area of the protrusion is smaller than a cross-sectional area of the coupling hole.

2. The camera module according to claim 1,
wherein an inner surface of the coupling hole includes:
a first surface;
a second surface disposed opposite to the first surface;
a third surface connecting the first surface and the second surface; and
a fourth surface connecting the first surface and the second surface and opposite to the third surface, and
wherein an outer surface of the protrusion is in contact with any one surface among the first to fourth surfaces.

3. The camera module according to claim 2,
wherein the outer surface of the protrusion is spaced apart from any one among the first to fourth surfaces and the other three surfaces.

4. The camera module according to claim 1,
wherein the shield member includes: a fence portion disposed between the first substrate and the second substrate; and
a coupling portion protruded downward from a lower end of the fence portion and having the coupling hole formed therein,
wherein a groove into which the coupling portion is coupled is formed on a side surface of the second substrate, and
wherein the protrusion is disposed on a bottom surface of the groove.

5. The camera module according to claim 4,
wherein on an outside of an area connected to an upper end of the connecting portion among a lower surface of the fence portion, a slit having a shape recessed upward more than other areas is disposed.

6. The camera module according to claim 4, including:
a contact portion extended downward from a lower end of the coupling portion and in contact with an inner surface of the rear body.

7. The camera module according to claim 4,
wherein the contact portion comprises:
a first area extended downwardly from a lower end of the coupling portion;
a second area extended downwardly from a lower end of the first area; and
a bending portion disposed between the first area and the second area and in contact with an inner surface of the rear body.

8. The camera module according to claim 7,
wherein the contact portion has elasticity such that an outer surface of the bending portion presses an inner surface of the rear body.

9. The camera module according to claim 7,
wherein the first area is disposed so as to be inclined so that the distance to an inner surface of the rear body becomes closer as it goes downward, and
wherein the second area is disposed so as to be inclined so that the distance to an inner surface of the rear body becomes farther as it goes downward.

10. The camera module according to claim 1,
wherein a length of the protrusion in a first direction is 0.4 mm to 0.6 mm or less of a length of the coupling hole in a first direction, and
wherein a length of the protrusion in a second direction perpendicular to the first direction is 0.2 mm to 0.3 mm or less of a length of the coupling hole in a second direction.

11. The camera module according to claim 4, wherein based on a direction perpendicular to an optical axis direction, a length of the groove is longer than a length of the coupling portion.

12. The camera module according to claim 1, wherein based on a first direction perpendicular to an optical axis direction, a length of the protrusion is smaller than a length of the coupling hole,
Wherein based on the optical axis direction, a length of the protrusion is smaller than a length of the coupling hole.

13. The camera module according to claim 1, comprising a connector coupled to a lower surface of the second substrate,
wherein the rear body includes a connector lead-out portion to which the connector is coupled on an inside.

14. The camera module according to claim 2, wherein the protrusion has a square cross-sectional shape.

15. The camera module according to claim 4, wherein an upper part of the fence portion is coupled to a lower surface of the first substrate by SMT.

16. A camera module comprising:
a front body including a hole;
a lens module having at least a portion thereof coupled to the hole;
a rear body coupled to a rear surface of the front body; and
a substrate module disposed within the rear body,
wherein the substrate module comprises:
a first substrate on which an image sensor is disposed;
a second substrate disposed at the rear of the first substrate; and
a shield member coupled to the first substrate and the second substrate,
wherein a protrusion is formed on a side surface of the second substrate,
wherein the shield member includes a coupling hole into which the protrusion is coupled, and
wherein at least a portion of the protrusion is spaced apart from an inner surface of the coupling hole.

17. The camera module according to claim 16, wherein the shield member includes: a fence portion disposed between the first substrate and the second substrate; and
a coupling portion protruded downward from a lower end of the fence portion and having the coupling hole formed therein,
wherein a groove into which the coupling portion is coupled is formed on a side surface of the second substrate, and
wherein the protrusion is disposed on a bottom surface of the groove.

18. The camera module according to claim 17, wherein on an outside of an area connected to an upper end of the connecting portion among a lower surface of the fence portion, a slit having a shape recessed upward more than other areas is disposed.

19. The camera module according to claim 17, including:
a contact portion extended downward from a lower end of the coupling portion and in contact with an inner surface of the rear body.

20. The camera module according to claim 16, wherein based on a first direction perpendicular to an optical axis direction, a length of the protrusion is smaller than a length of the coupling hole,
Wherein based on the optical axis direction, a length of the protrusion is smaller than a length of the coupling hole.
